(19) United States
(12) Patent Application Publication
(10) Pub. No.: US 2022/0398789 A1
(43) Pub. Date: Dec. 15, 2022

(54) Method for Channel Drawing and Three-buy and Three-sell Marking Based on Stock Software

(71) Applicant: Shenzhen Qianhai Jiamay Information Technology Co., Ltd., Shenzhen (CN)

(72) Inventor: Longhua LIU, Nanning City (CN)

(21) Appl. No.: 17/343,177

(22) Filed: Jun. 9, 2021

(51) Int. Cl. G06T 11/20; G06Q 40/06

(52) U.S. Cl. CPC G06T 11/206; G06Q 40/06

(57) ABSTRACT

The present disclosure relates to stock information processing technology, and in particular to a method comprising: simplifying a candlestick chart of a digital entanglement principle model and defining candlestick sections; determining an inclusion relation between the candlestick sections; processing the inclusion relation in a certain direction; making trendlines by connecting new candlesticks obtained over several days; after trendlines are established, drawing a channel by trendlines; determining an end of the channel; marking; wherein the candlestick chart of a digital entanglement principle model is simplified to determine the candlestick sections, then the inclusion relation between the candlestick sections is determined to obtain new simplified candlesticks, a channel is obtained after making trendlines by connection, three buying points and three selling points are quickly marked after the channel ends, and lines are made to draw a channel to determine the position of the three buying points and three selling points.

### FIELD OF THE INVENTION

The present invention belongs to the field of stock information processing technology, and in particular to a method for channel drawing and three-buy and three-sell marking based on stock software.

### DESCRIPTION OF THE PRIOR ART

Stock is a share in the ownership of a joint-stock company, and also the ownership certificate issued. It is a kind of securities issued by joint-stock companies to each shareholder as a certificate of shareholding to raise funds and thereby obtain dividends and bonuses. Stock is a long-term credit tool in the capital market and can be transferred, bought and sold. With it, shareholders can share in the company's profits but shall also bear the risks arising from improper operations of the company. Each share represents a basic unit of ownership of the company from which shareholders bought it.

CN108255800A (a Chinese patent document) discloses a customer platform based on stock trends, consisting of two parts: products and technologies. The part of products includes window Title (location point); fields (location point, price, time); buttons (confirm, cancel). The part of technologies involves Mac chart interface, which is divided into layers as follows: layer of chart views used for displaying candlesticks, positions, current price lines, closing price lines yesterday, gaps and other information; layer of candlesticks used for directly displaying stock price information and transmission of some data. Through the customer platform based on stock trends, the X-axis and Y-axis coordinates of lines to be drawn are determined by inputting prices and time corresponding to location points to achieve precise line drawing, but certain defects still exist in actual use: 1. Lack of ability to determine and select line drawing conditions, which affects the accuracy of line drawing; 2. Lack of ability to conduct visual processing on stock market, which affects the understanding of users on stock price fluctuations; 3. Lack of ability to perform appropriate marking of three buying points and three selling points, which cannot achieve easy observation.

### SUMMARY OF THE INVENTION

The present invention is designed to solve the following problems: 1. Lack of ability to determine and select line drawing conditions, which affects the accuracy of line drawing; 2. Lack of ability to conduct visual processing on stock market, which affects the understanding of users on stock price fluctuations; 3. Lack of ability to perform appropriate marking of three buying points and three selling points, which cannot achieve easy observation. Therefore, a method for channel drawing and three-buy and three-sell marking based on stock software is proposed herein.

In order to achieve the above purposes, the present invention adopts the following technical scheme.

A method for channel drawing and three-buy and three-sell marking based on stock software, includes the following steps:

S1: Simplify the candlestick chart of a digital entanglement principle model and define the candlestick sections;

S2: Determine the inclusion relation between the defined candlestick sections; S3: Process the inclusion relation by determining the sequence and performing upward or downward processing to obtain new simplified candlesticks;

S4: Make trendlines by connecting new candlesticks obtained over several days. trendlines include upward trendlines and downward trendlines. When there is a change in upward or downward direction, the upward or downward trendline in the segment ends. When a trendline structure is destroyed, establish a new trendline. End the trendline after determining its newest point;

S5: After trendlines are established, comprise a channel by trendlines. The section of the channel is determined by the area formed by the first three overlapping trendlines. The direction of the channel is determined by the entering trendline. When the entering trendline is an upward trendline, the channel is upward. When the entering trendline is a downward trendline, the channel is downward, which means that a trendline leaves the channel section;

S6: Determine the end of the channel when the subsequent callback trendline does not enter the range of the section of the channel again, and a new trendline continues to produce in the opposite direction;

S7: Mark. When the channel ends, the reverse channel also ends.

A further description of the above technical scheme:

The inclusion relation in the S2 is an inclusion relation between two adjacent candlestick sections, and the inclusion relation includes: the same lowest price, the same highest price, the same highest price, the same lowest price, and two mutually complete inclusion relations.

A further description of the above technical scheme:

Only four types occur between two adjacent “candlestick sections” in the S3, i.e. falling type, rising type, bottom type and top type.

A further description of the above technical scheme:

The trendlines in the S4 include upward trendline=bottom type+candlesticks+top type and downward trendline=top type+candlesticks+bottom type.

A further description of the above technical scheme:

The condition for the establishment of trendlines in the S4 is that the whole top type body of a candlestick after inclusion processing must be higher than the whole bottom type body. When inclusion processing is not performed, the number of candlesticks between the highest top type candlestick and the lowest bottom type candlestick must be greater than or equal to three. After inclusion processing, the top type and the bottom type cannot share candlesticks.

A further description of the above technical scheme:

In the S4, when new trendlines that meet the condition do not occur, there are multiple top or bottom types in succession, and same high point of two or more top types or same low point of bottom types. When a new high point occurs and the condition for a trendline is not met, it indicates an extension of a trendline. When a new low point occurs and trendline adjustment is not met, it indicates an extension of a trendline until a new condition for a trendline establishes.

A further description of the above technical scheme:

The destroying of a trendline structure in the S4 refers to the emergence of new candlesticks and continuous destroying of trendlines that have been established and ended. Due to the presence of new candlesticks, the trendlines that have been established and ended need to be reconnected. There are only two types of trendline destroying, namely top type upward trendline destroying and bottom type downward trendline destroying.

A further description of the above technical scheme:

In the S7, when determining there is a condition for an upward channel, three buying points occur, and when determining there is a condition for a downward channel, three selling points occur, and the channel in the opposite direction ends. When determining there is a condition for an upward channel, three selling points occur, and when determining there is a condition for a downward channel, three buying points occur, three buys and three sells are marked, and the marking ends.

To sum up, due to the adoption of the above technical scheme, the present invention has the following beneficial effects:

1. In the present invention, the candlestick chart of a digital entanglement principle model is simplified to define the candlestick sections, and then the inclusion relation between the candlestick sections is determined to obtain new simplified candlesticks. In addition, a channel is obtained after making trendlines by connection, three buying points and three selling points are quickly marked after the channel ends, and trendlines are made to draw a channel to determine the position of the three buying points and three selling points, which can effectively simplify the difficulty of marking, improve the efficiency of marking, easily adapt to real-time changes in stock market, achieve visual processing and observation of stock market, help understand stock price fluctuations, and improve the efficiency of analysis.

### DETAILED DESCRIPTION OF THE EMBODIMENTS

The technical scheme provided in the embodiments of the present invention will be clearly and completely described below with reference to the accompanying drawings in the embodiments of the present invention. Obviously, the embodiments described are only a part rather than all the embodiments of the present invention. Based on the embodiments of the present invention, all other embodiments obtained by persons of ordinary skill in the art without creative work shall fall within the scope of protection of the present invention.

### Embodiment 1

The present invention provides a technical scheme: a method for central drawing and three-buy and three-sell marking based on stock software, including the following steps:

S1: Simplify the candlestick chart of a digital entanglement principle model and define the candlestick sections;

S2: Determine the inclusion relation between the defined candlestick sections;

S3: Process the inclusion relation by determining the sequence and performing upward or downward processing to obtain new simplified candlesticks;

S4: Make trendlines by connecting new candlesticks obtained over several days. Trendlines include upward trendlines and downward trendlines. When there is a change in upward or downward direction, the upward or downward trendline in the segment ends. When a trendline structure is destroyed, establish a new trendline. End the trendline after determining its newest point;

S5: After trendlines are established, comprise a channel by trendlines. The section of the channel is determined by the area formed by the first three overlapping trendlines. The direction of the channel is determined by the entering trendline. When the entering trendline is an upward trendline, the channel is upward. When the entering trendline is a downward trendline, the channel is downward, which means that a trendline leaves the channel section;

S6: Determine the end of the channel when the subsequent callback trendline does not enter the range of the section of the channel again, and a new trendline continues to produce in the opposite direction;

S7: Mark. When the channel ends, the reverse channel also ends.

The inclusion relation in the S2 is an inclusion relation between two adjacent candlestick sections, and the inclusion relation includes: the same lowest price, the same highest price, the same highest price, the same lowest price, and two mutually complete inclusion relations.

Only four types occur between two adjacent “candlestick sections” in the S3, i.e. falling type, rising type, bottom type and top type.

The trendlines in the S4 include upward trendline=bottom type+candlesticks+top type and downward trendline=top type+candlesticks+bottom type.

The condition for the establishment of trendlines in the S4 is that the whole top type body of a candlestick after inclusion processing must be higher than the whole bottom type body. When inclusion processing is not performed, the number of candlesticks between the highest top type candlestick and the lowest bottom type candlestick must be greater than or equal to three. After inclusion processing, the top type and the bottom type cannot share candlesticks.

In the S4, when new trendlines that meet the condition do not occur, there are multiple top or bottom types in succession, and same high point of two or more top types or same low point of bottom types. When a new high point occurs and the condition for a trendline is not met, it indicates an extension of a trendline. When a new low point occurs and trendline adjustment is not met, it indicates an extension of a trendline until a new condition for a trendline establishes.

In the S7, when determining there is a condition for an upward channel, three buying points occur, and when determining there is a condition for a downward channel, three selling points occur, and the channel in the opposite direction ends. When determining there is a condition for an upward channel, three selling points occur, and when determining there is a condition for a downward channel, three buying points occur, three buys and three sells are marked, and the marking ends.

The specific implementation is as follows: Make trendlines, draw channel sections, and mark three buying points and three selling points according to the model, which can simplify the complicated and changeable trend diagrams on the candlestick chart, and greatly help users in analysis and making a clear distinguish between upward trend and downward trend. The candlestick chart of a digital entanglement principle model is simplified to define candlestick sections, and then the inclusion relation between the candlestick sections is determined to obtain new simplified candlesticks. In addition, a channel is obtained after making trendlines by connection, three buying points and three selling points are quickly marked after the channel ends, and trendlines are made to draw a channel to determine the position of the three buying points and three selling points, which can effectively simplify the difficulty of marking, improve the efficiency of marking, easily adapt to real-time changes in stock market, achieve visual processing and observation of stock market, help understand stock price fluctuations, and improve the efficiency of analysis.

### Embodiment 2

The present invention provides a technical scheme: a method for central drawing and three-buy and three-sell marking based on stock software, including the following steps:

S1: Simplify the candlestick chart of a digital entanglement principle model and define the candlestick sections;

S2: Determine the inclusion relation between the defined candlestick sections;

S3: Process the inclusion relation by determining the sequence and performing upward or downward processing to obtain new simplified candlesticks;

S4: Make trendlines by connecting new candlesticks obtained over several days. Trendlines include upward trendlines and downward trendlines. When there is a change in upward or downward direction, the upward or downward trendline in the segment ends. When a trendline structure is destroyed, establish a new trendline. End the trendline after determining its newest point;

S5: After trendlines are established, comprise a channel by trendlines. The section of the channel is determined by the area formed by the first three overlapping trendlines. The direction of the channel is determined by the entering trendline. When the entering trendline is an upward trendline, the channel is upward. When the entering trendline is a downward trendline, the channel is downward, which means that a trendline leaves the channel section;

S6: Determine the end of the channel when the subsequent callback trendline does not enter the range of the section of the channel again, and a new trendline continues to produce in the opposite direction;

S7: Mark. When the channel ends, the reverse channel also ends.

The inclusion relation in the S2 is an inclusion relation between two adjacent candlestick sections, and the inclusion relation includes: the same lowest price, the same highest price, the same highest price, the same lowest price, and two mutually complete inclusion relations.

Only four types occur between two adjacent “candlestick sections” in the S3, i.e. falling type, rising type, bottom type and top type.

The trendlines in the S4 include upward trendline=bottom type+candlesticks+top type and downward trendline=top type+candlesticks+bottom type.

The condition for the establishment of trendlines in the S4 is that the whole top type body of a candlestick after inclusion processing must be higher than the whole bottom type body. When inclusion processing is not performed, the number of candlesticks between the highest top type candlestick and the lowest bottom type candlestick must be greater than or equal to three. After inclusion processing, the top type and the bottom type cannot share candlesticks.

In the S4, when new trendlines that meet the condition do not occur, there are multiple top or bottom types in succession, and same high point of two or more top types or same low point of bottom types. When a new high point occurs and the condition for a trendline is not met, it indicates an extension of a trendline. When a new low point occurs and trendline adjustment is not met, it indicates an extension of a trendline until a new condition for a trendline establishes.

In the S7, when determining there is a condition for an upward channel, three buying points occur, and when determining there is a condition for a downward channel, three selling points occur, and the channel in the opposite direction ends. When determining there is a condition for an upward channel, three selling points occur, and when determining there is a condition for a downward channel, three buying points occur, three buys and three sells are marked, and the marking ends.

The specific implementation is as follows: When determining the starting point of a trendline, in the first case, if the highest point and the lowest point do not occur on the same candlestick, and the first candlestick has the highest point or the lowest point, assume that a virtual top type and bottom type exists (i.e. the candlestick with the lowest point is regarded as the lowest point of the virtual bottom type, and the candlestick with the highest point is regarded as the highest point of the top type). If the seven candlesticks meet the condition of a trendline (standard trendline) at this moment, make trendlines (if the condition is not met, do not draw, but the starting point is the same). If it is a downward trendline, take the lowest point as the starting point of a trendline. If it is an upward trendline, take the highest point as the starting point of a trendline. If the seven candlesticks do not meet the condition of a trendline at this moment, there will be two cases (i.e. only new high points or new low points will occur in the future). 01: If a new low point occurs, it is a downward trendline and take the highest point as the starting point of the trendline. 02: If a new high point occurs, it is an upward trendline and take the lowest point as the starting point of the trendline. When no new trendlines occur in the future, a top type appears or a downward extension into a trendline destroys the upward trendline type, reconnect the starting point of the trendline. Reversely, if a bottom type appears or an upward extension into a trendline destroys the downward trendline type, the starting point also needs to be reconnected. Under normal circumstances, if the composition of a downward trendline by top type starting from A is established in the future, then the starting point of the trendline is from A. If not established, a new candlestick (red box) breaks the highest point of A, then the starting point of the trendline needs to be from B if the condition for a trendline is met in the future, and the like. When a new high point or a new low point occurs and the condition for a trendline is not met, the trendline will start from the highest point if it is a downward trendline and the condition for a trendline is met in the future. Conversely, if it is an upward trendline, the trendline will start from the lowest point. In the future, the upward trendline formed by bottom type starting from A will be established, then the starting point of the trendline is from A. If not established, and a new candlestick breaks below the lowest point of A (green box), then the trendline needs to start from B if the condition for a trendline is met in the future, and the like. When a new high point or a new low point occurs and the condition for a trendline is not met, the trendline will start from the highest point if it is a downward trendline and the condition for a trendline is met in the future. Conversely, if it is an upward trendline, the trendline will start from the lowest point.

When determining the starting point of a trendline, in the second case, if the highest point and the lowest point do not occur on the same candlestick, and the first candlestick has not the highest point or the lowest point, then a virtual top type or bottom type is not necessary. The trendline starts from the first top type or the first bottom type, and the seven candlesticks meet the condition of a trendline. If it is a downward trendline, take the lowest point of the first bottom type as the starting point of the trendline. If it is an upward trendline, take the highest point of the first top type as the starting point of the trendline. There will be two cases (i.e. only new high points or new low points will occur in the future). 01: If a new low point occurs, it is a downward trendline and take the highest point as the starting point of the trendline. 02: If a new high point occurs, it is an upward trendline and take the lowest point as the starting point of the trendline. It should be noted that no matter how long a candlestick lasts, there are only the two cases. If in the future, before a new trendline occurs, type breaks trendlines or extends downward or upward into a trendline to destroy trendline type, the starting point of the trendline needs to be reconnected, exactly the same as the first group.

When the highest point and the lowest point occur on the same candlestick, the condition for a trendline cannot be met at this moment. Therefore, process the inclusion relation between the first candlestick and the second candlestick, and then continue to perform processing according to the first and second cases, because the starting point of a trendline is related to the direction of both the trendline and the channel later. Therefore, the starting point needs to be specially processed. In fact, the special processing involves several simple fixed models. Note that this special processing only applies to the starting point of a trendline, that is, once the second trendline occurs after the first downward or upward trendline, perform processing as that under normal conditions.

### Embodiment 3

The present invention provides a technical scheme: a method for central drawing and three-buy and three-sell marking based on stock software, including the following steps:

S1: Simplify the candlestick chart of a digital entanglement principle model and define the candlestick sections;

S2: Determine the inclusion relation between the defined candlestick sections;

S3: Process the inclusion relation by determining the sequence and performing upward or downward processing to obtain new simplified candlesticks;

S4: Make trendlines by connecting new candlesticks obtained over several days. Trendlines include upward trendlines and downward trendlines. When there is a change in upward or downward direction, the upward or downward trendline in the segment ends. When a trendline structure is destroyed, establish a new trendline. End the trendline after determining its newest point;

S5: After trendlines are established, comprise a channel by trendlines. The section of the channel is determined by the area formed by the first three overlapping trendlines. The direction of the channel is determined by the entering trendline. When the entering trendline is an upward trendline, the channel is upward. When the entering trendline is a downward trendline, the channel is downward, which means that a trendline leaves the channel section;

S6: Determine the end of the channel when the subsequent callback trendline does not enter the range of the section of the channel again, and a new trendline continues to produce in the opposite direction;

S7: Mark. When the channel ends, the reverse channel also ends.

The inclusion relation in the S2 is an inclusion relation between two adjacent candlestick sections, and the inclusion relation includes: the same lowest price, the same highest price, the same highest price, the same lowest price, and two mutually complete inclusion relations.

Only four types occur between two adjacent “candlestick sections” in the S3, i.e. falling type, rising type, bottom type and top type.

The trendlines in the S4 include upward trendline=bottom type+candlesticks+top type and downward trendline=top type+candlesticks+bottom type.

The condition for the establishment of trendlines in the S4 is that the whole top type body of a candlestick after inclusion processing must be higher than the whole bottom type body. When inclusion processing is not performed, the number of candlesticks between the highest top type candlestick and the lowest bottom type candlestick must be greater than or equal to three. After inclusion processing, the top type and the bottom type cannot share candlesticks.

In the S4, when new trendlines that meet the condition do not occur, there are multiple top or bottom types in succession, and same high point of two or more top types or same low point of bottom types. When a new high point occurs and the condition for a trendline is not met, it indicates an extension of a trendline. When a new low point occurs and trendline adjustment is not met, it indicates an extension of a trendline until a new condition for a trendline establishes.

In the S7, when determining there is a condition for an upward channel, three buying points occur, and when determining there is a condition for a downward channel, three selling points occur, and the channel in the opposite direction ends. When determining there is a condition for an upward channel, three selling points occur, and when determining there is a condition for a downward channel, three buying points occur, three buys and three sells are marked, and the marking ends.

The specific implementation is as follows: When generating the newest point (connection to the current newest candlestick) of a trendline, candlestick statistics change as stock prices change in real time. Therefore, it is unlikely that all the newest candlesticks will immediately meet the conditions of a trendline. The newest point needs to be processed simply. The newest connection point shows the movement of top/bottom type, extension into a trendline and continuation of the trendline: movement range of top/bottom type, direct connection to the highest/lowest point. If it is the movement of a top/bottom type when the condition for a trendline is met, use a solid line to connect to the lowest point of the bottom type or the highest point of the top type as shown in the figure below. If it is the movement of a top/bottom type formed in the process of extending into a trendline, connect to the newest candlestick with a dotted line; also connect with a dotted line in the process of extending into a trendline. When a downward trendline extends, connect to the lowest point of the newest candlestick. Conversely, when an upward trendline extends, connect to the highest point of the newest candlestick. The extension of a trendline also indicates a connection between the highest point and the lowest point. A solid line should be drawn because it is already a trendline.

The description above only refers to the preferred specific embodiments of the present invention and shall not limit the scope of protection of the invention. Equivalent replacements or changes made by anyone familiar with the technical field according to the technical scheme and the inventive concept of the present invention within the scope of the technology disclosed by the present invention shall fall into the scope of protection of the present invention.

What is claimed is:

1. A method for channel drawing and three-buy and three-sell marking based on stock software, comprising the following steps:
S1: simplifying a candlestick chart of a digital entanglement principle model and defining candlestick sections;
S2: determining an inclusion relation between the candlestick sections;
S3: processing the inclusion relation by determining a sequence and performing upward or downward processing to obtain new simplified candlesticks;
S4 making trendlines by connecting new candlesticks obtained over several days, wherein the trendlines comprise upward trendlines and downward trendlines, wherein when there is a change in upward or downward direction, the upward trendline or the downward trendline in a segment ends, and when a trendline structure is destroyed, a new trendline is established, and a trendline is ended after determining a newest point of the trendline;
S5: after the trendlines are established, drawing a channel by trendlines, wherein a section of the channel is determined by an area formed by a first three overlapping trendlines, a direction of the channel is determined by an entering trendline, when the entering trendline is an upward trendline, the channel is upward, and when the entering trendline is a downward trendline, the channel is downward, which means that the entering trendline leaves the section of the channel;
S6: determining an end of the channel when a subsequent callback trendline does not enter a range of the section of the channel again, and a new trendline continues to produce in an opposite direction; and
S7: marking, when the channel ends, a reverse channel also ends.

2. The method for channel drawing and three-buy and three-sell marking based on stock software according to claim 1, wherein the inclusion relation in the S2 is an inclusion relation between two adjacent candlestick sections, and the inclusion relation comprises: a same lowest price, a same highest price, and two mutually complete inclusion relations.

3. The method for channel drawing and three-buy and three-sell marking based on stock software according to claim 1, wherein only four types occur between two adjacent candlestick sections in the S3, wherein the four types are falling type, rising type, bottom type, and top type.

4. The method for channel drawing and three-buy and three-sell marking based on stock software according to claim 1, wherein the trendlines in the S4 comprise the upward trendline=bottom type+candlesticks+top type and downward trendline=top type+candlesticks+bottom type.

5. The method for channel drawing and three-buy and three-sell marking based on stock software according to claim 1, wherein a condition for establishment of the trendline in the S4 is that a whole top type body of a candlestick after inclusion processing must be higher than a whole bottom type body, when the inclusion processing is not performed, a number of candlesticks between a highest top type candlestick and a lowest bottom type candlestick must be greater than or equal to three, and after the inclusion processing, a top type and a bottom type cannot share candlesticks.

6. The method for channel drawing and three-buy and three-sell marking based on stock software according to claim 1, wherein, in the S4, when new trendlines that meet a condition do not occur, there are multiple top types or bottom types in succession, and a same high point of two or more of the multiple top types or a same low point of two or more of the multiple bottom types, when a new high point occurs and the condition for the trendline is not met, an extension of a trendline is indicated, and when a new low point occurs and trendline adjustment is not met, the extension of the trendline is indicated until a new condition for the trendline is established.

7. The method for channel drawing and three-buy and three-sell marking based on stock software according to claim 1, wherein destroying of the trendline structure in the S4 refers to an emergence of the new candlesticks and continuous destroying of trendlines that have been established and ended, due to a presence of the new candlesticks, the trendlines that have been established and ended need to be reconnected, and there are only two types of trendline destroying, wherein the two types of trendline destroying are top type upward trendline destroying and bottom type downward trendline destroying.

8. The method for channel drawing and three-buy and three-sell marking based on stock software according to claim 1, wherein, in the S7, when determining there is a condition for an upward channel, three buying points occur, and when determining there is a condition for a downward channel, three selling points occur, and the channel in the opposite direction ends, when determining there is the condition for the upward channel, the three selling points occur, and when determining there is the condition for the downward channel, the three buying points occur, three buys and three sells are marked, and the marking ends.
